(19) United States
(12) Patent Application Publication
(10) Pub. No.: US 2015/0034572 A1
(43) Pub. Date: Feb. 5, 2015

(54) MAGNETIC POSITIONING FRAME FOR SOCKET BITS

(71) Applicant: Jui-Chien KAO, TAICHUNG CITY (TW)

(72) Inventor: Jui-Chien KAO, TAICHUNG CITY (TW)

(21) Appl. No.: 13/958,061

(22) Filed: Aug. 2, 2013

(51) Int. Cl. B25H 3/04; B25B 13/06; B25B 13/56

(52) U.S. Cl. CPC B25H 3/04; B25B 13/56; B25B 13/06
USPC 211/13.1

(57) ABSTRACT

A magnetic positioning frame for socket bits has a track disc, a supporting device and a magnetic device. The track disc has a baseboard, multiple positioning racks, multiple positioning blocks, at least one mounting rack and multiple holding racks. The supporting device is connected to the track disc and has multiple fixing boards and two supporting mounts. The magnetic device is connected to the track disc and has at least two attracting modules, each attracting module has a locating board, an outer casing, a magnet block and a fastener. The locating board is movably mounted in the at least one mounting rack. The outer casing abuts the at least one mounting rack and has a through hole and a mounting recess. The magnet block is mounted in the mounting recess and has a holding hole. The fastener extends through the through hole and is connected to the connecting hole.

### BACKGROUND OF THE INVENTION

1. Field of the Invention

The present invention relates to a magnetic positioning frame, and more particularly to a magnetic positioning frame for socket bits that can be mounted on a sidewall of a tool cabinet conveniently.

2. Description of the Prior Art

A conventional positioning frame for socket bits has a track disc and multiple positioning blocks. The track disc has a front surface and multiple racks. The racks are formed in the front surface of the track disc at intervals. The positioning blocks are slidably mounted in the racks of the track disc. The user can store and display the socket bits by mounting the socket bits around the positioning blocks.

However, though the conventional positioning frame for socket bits can position the socket bits, the conventional positioning frame cannot be mounted on a sidewall of a tool cabinet, needs a large space for storage, and this is inconvenient in use.

To overcome the shortcomings, the present invention provides a magnetic positioning frame for socket bits to mitigate the aforementioned problems.

### SUMMARY OF THE INVENTION

The main objective of the present invention is to provide a magnetic positioning frame for socket bits that can be mounted on a sidewall of a tool cabinet conveniently.

The magnetic positioning frame for socket bits in accordance with the present invention has a track disc, a supporting device and a magnetic device. The track disc has a baseboard, multiple positioning racks, multiple positioning blocks, at least one mounting rack and multiple holding racks. The supporting device is detachably connected to the track disc and has multiple fixing boards and two supporting mounts. The magnetic device is connected to the track disc and has at least two attracting modules, and each attracting module has a locating board, an outer casing, a magnet block and a fastener. The locating board is movably mounted in the at least one mounting rack. The outer casing abuts the at least one mounting rack and has a through hole and a mounting recess. The magnet block is mounted in the mounting recess and has a holding hole. The fastener extends through the through hole and is connected to the connecting hole.

Other objects, advantages and novel features of the invention will become more apparent from the following detailed description when taken in conjunction with the accompanying drawings.

### BRIEF DESCRIPTION OF THE DRAWINGS

FIG. 1 is a front perspective view of a magnetic positioning frame in accordance with the present invention;

FIG. 2 is a rear perspective view of the magnetic positioning frame in accordance with the present invention;

FIG. 3 is an enlarged side view in partial section of the magnetic positioning frame across line 3-3 in FIG. 2;

FIG. 4 is an exploded rear perspective view of the magnetic positioning frame in FIG. 2;

FIG. 5 is an enlarged and exploded rear perspective view of the magnetic positioning frame in FIG. 2; and

FIG. 6 is an operational perspective view of the magnetic positioning frame in FIG. 1, mounted on a sidewall of a tool cabinet.

### DETAILED DESCRIPTION OF THE PREFERRED EMBODIMENT

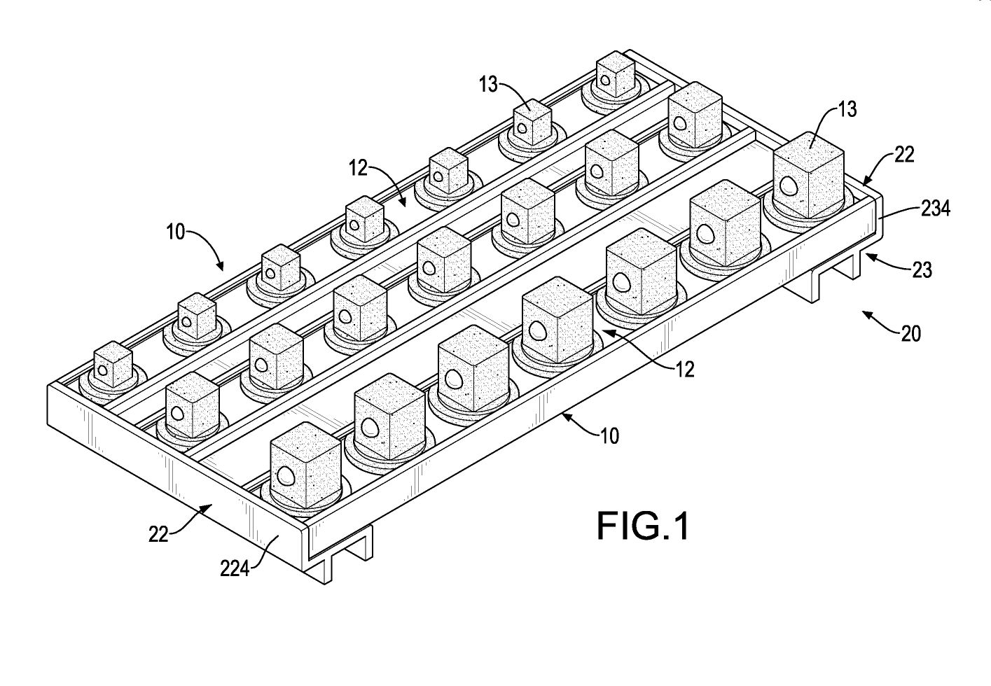

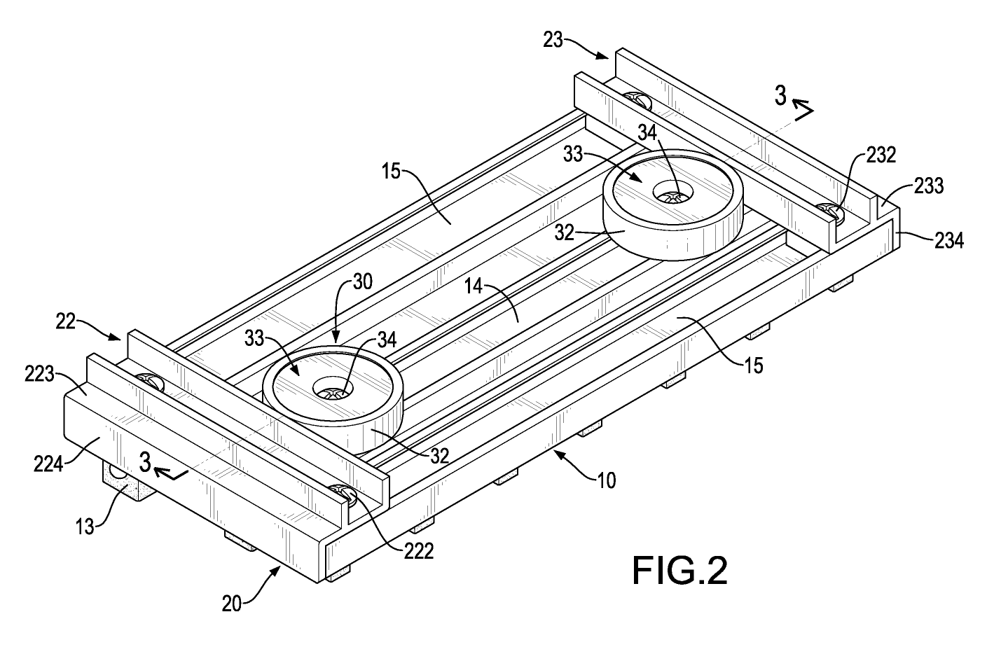

With reference to FIGS. 1 to 3, a magnetic positioning frame for socket bits in accordance with the present invention has a track disc 10, a supporting device 20 and a magnetic device 30.

The track disc 10 is made by aluminum extrusion, is elongated and has a baseboard 11, multiple positioning racks 12, multiple positioning blocks 13, at least one mounting rack 14 and multiple holding racks 15.

The baseboard 11 may be rectangular in shape and has a top surface, a bottom surface, a length, and two opposite sides including a first side and a second side. The positioning racks 12 are formed on and protrude from the top surface of the baseboard 11 at intervals, and each positioning rack 12 has a length equal to the length of the baseboard 11. The positioning blocks 13 are mounted slidably in the positioning racks 12 of the track disc 10 to hold socket bits on the track disc 10. The at least one mounting rack 14 is formed on and protrudes from the bottom surface of the baseboard 11. The holding racks 15 are formed on and protrude from the bottom surface of the baseboard 11 and beside the at least one mounting rack 14.

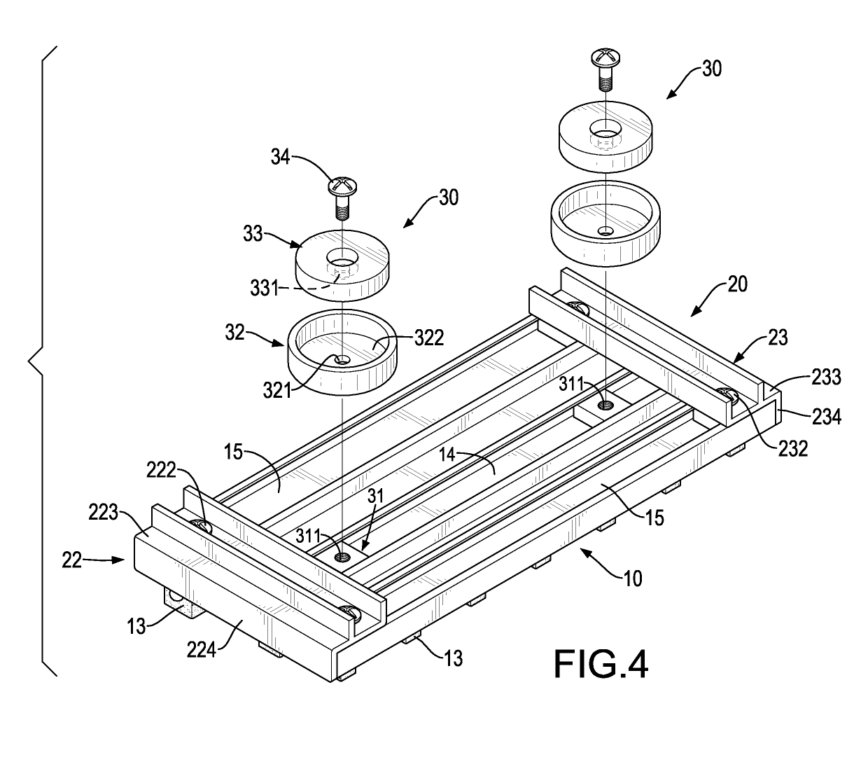

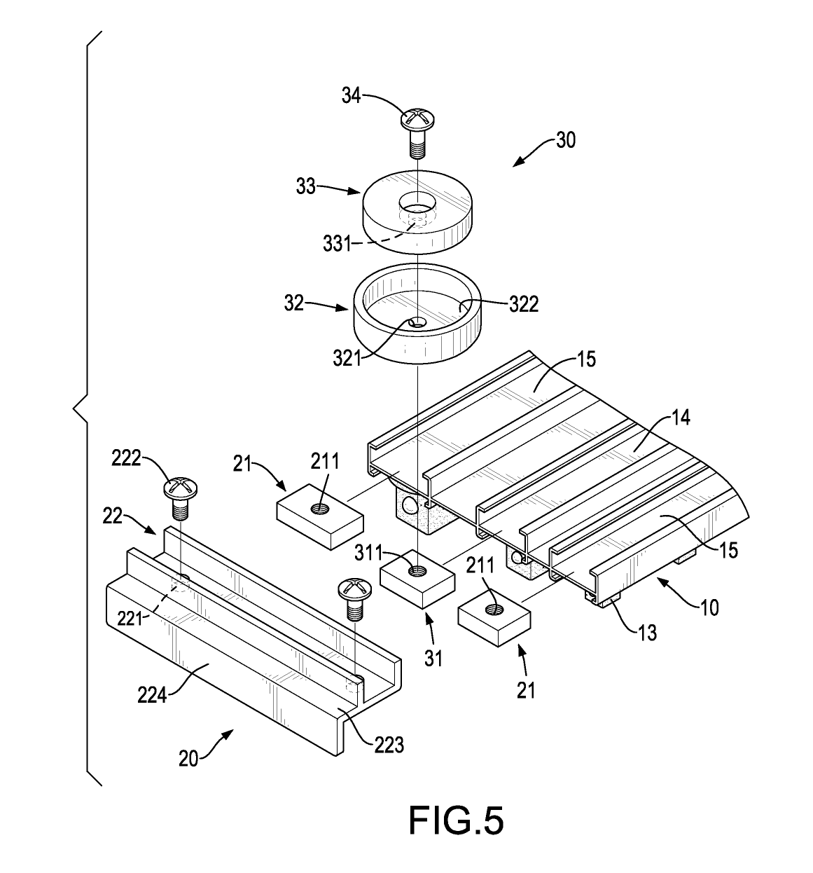

With reference to FIGS. 4 and 5, the supporting device 20 is detachably connected to the track disc 10 and has multiple fixing boards 21, a first supporting mount 22 and a second supporting mount 23. The fixing boards 21 may be quadrate, are movably mounted in the holding racks 15 adjacent to the opposite sides of the baseboard 11. Each fixing board 21 has a fixing hole 211 formed through the fixing board 21.

The first supporting mount 22 is made by aluminum extrusion, is connected to the bottom surface and the first side of the baseboard 11 and has a top, a bottom, an outer side, multiple through holes 221, multiple screw bolts 222, an extending tab 223 and a side panel 224. The through holes 221 are formed through the bottom and the top of the first supporting mount 22 at intervals and respectively align with the fixing holes 211 of the fixing boards 21 that are mounted on the first side of the baseboard 11. The screw bolts 222 are respectively mounted through the through holes 221 of the first supporting mount 22 and are respectively and securely mounted in the fixing holes 211 of the fixing boards 21 via the holding racks 15 to connect the first supporting mount 22 securely to the fixing boards 21 at the first side of the baseboard 11 and to connect the first supporting mount 22 securely to the bottom surface of the baseboard 11.

The extending tab 223 is formed on and transversally protrudes from the outer side of the first supporting mount 22 at the top of the first supporting mount 22, abuts the bottom surface of the baseboard 11 and has an outer side. The side panel 224 is formed on and upwardly protrudes from the outer side of the extending tab 223 to close the positioning racks 12 and the holding racks 15 at the first side of the baseboard 11 to prevent the positioning blocks 13 from separating from the first side of the baseboard 11.

The second supporting mount 23 is made by aluminum extrusion and is connected to the bottom surface and the second side of the baseboard 11. The second supporting mount 23 has a top, a bottom, an outer side, multiple through holes 231, multiple screw bolts 232, an extending tab 233 and a side panel 234. The through holes 231 are formed through the top and the bottom of the second supporting mount 23 at intervals and respectively align with the fixing holes 211 of the fixing boards 21 that are mounted on the second side of the baseboard 11. The screw bolts 232 are respectively mounted through the through holes 231 of the second supporting mount 23 and are respectively and securely mounted in the fixing holes 211 of the fixing boards 21 via the holding racks 15 to connect the second supporting mount 23 securely with the fixing boards 21 at the second side of the baseboard 11 and to connect the second supporting mount 23 securely to the bottom surface of the baseboard 11.

The extending tab 233 is formed on and transversally protrudes from the outer side of the second supporting mount 23, is formed at the top of the second supporting mount 23, abuts the bottom surface of the baseboard 11 and has an outer side. The side panel 234 is formed on and upwardly protrudes from the outer side of the extending tab 233 to close the positioning racks 12 and the holding racks 15 at the second side of the baseboard 11 to prevent the positioning blocks 13 from separating from the second side of the baseboard 11. Accordingly, the supporting mounts 22, 23 are respectively connected to the opposite sides of the baseboard 11 to reinforce the structural strength of the track disc 10.

The magnetic device 30 is connected to the track disc 10 and has at least two attracting modules, and each one of the attracting modules has a locating board 31, an outer casing 32, a magnet block 33 and a fastener 34. The locating board 31 may be quadrate, is movably mounted in the at least one mounting rack 14 adjacent to one of the supporting mounts 22, 23, and has a connecting hole 311 formed through the locating board 31.

The outer casing 32 abuts the at least mounting rack 14 below the baseboard 11 and has a closed bottom, an open top, a through hole 321 and a mounting recess 322. The closed bottom of the outer casing 32 abuts the at least one mounting rack 14. The through hole 321 is formed through the closed bottom of the outer casing 32 and aligns with the connecting hole 311 of the locating board 31 via the at least one mounting rack 14. The mounting recess 322 is formed in the outer casing 32 between the closed bottom and the open top of the outer casing 32, communicates with the through hole 321 and the open top of the outer casing 32 and has a depth.

The magnet block 33 is mounted in the mounting recess 322 of the outer casing 32 and has a thickness, a top surface and a holding hole 331. The thickness of the magnet block 33 is thinner than the depth of the mounting recess 322. Accordingly, the top surface of the magnet block 33 is mounted in the mounting recess 322 and does not extend out of the open top of the outer casing 32. The holding hole 331 is formed through the magnet block 33 and aligns with the through hole 321 of the outer casing 32 and the connecting hole 311 of the locating board 31.

The fastener 34 is mounted in the holding hole 331 of the magnet block 33, extends through the through hole 321 of the outer casing 32 and is connected to the connecting hole 311 of the locating board 31 via the at least one mounting rack 14 to hold the magnet block 33 and the outer casing 32 securely with the locating board 31 to connect the attracting module to the at least one mounting rack 14 below the baseboard 11.

In use, the user can store socket bits by mounting the socket bits around the positioning blocks 13 of the track disc 10. After mounting and storing the socket bits with the track disc 10, the user can mount the magnetic positioning frame on a sidewall 51 of a tool cabinet 50 conveniently by the magnetic forces of the magnet blocks 33 attracted to the sidewall 51 of the tool cabinet 50. Then, the socket bits can be mounted and displayed on the sidewall 51 of the tool cabinet 50 with the magnetic positioning frame. Accordingly, no space in the tool cabinet 50 is needed for storing the magnetic positioning frame.

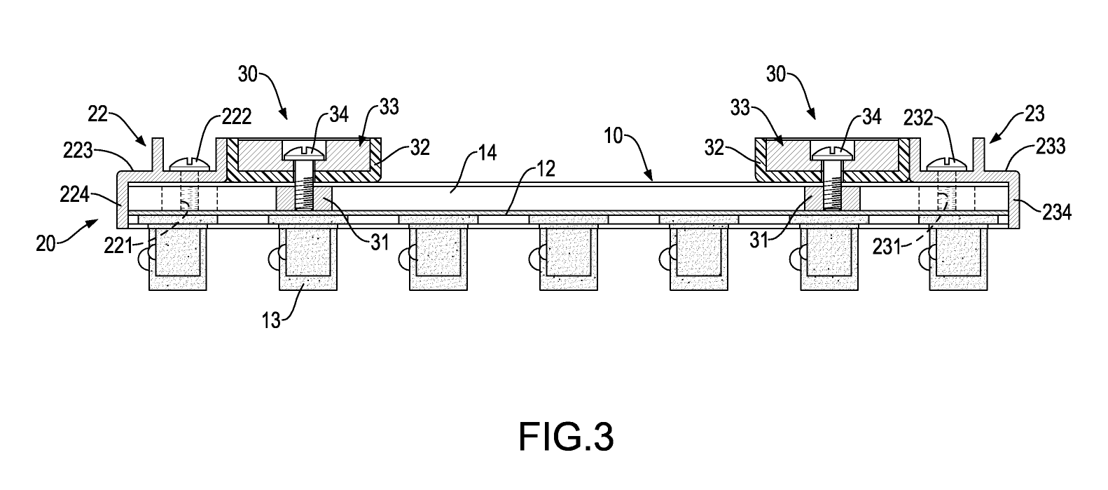

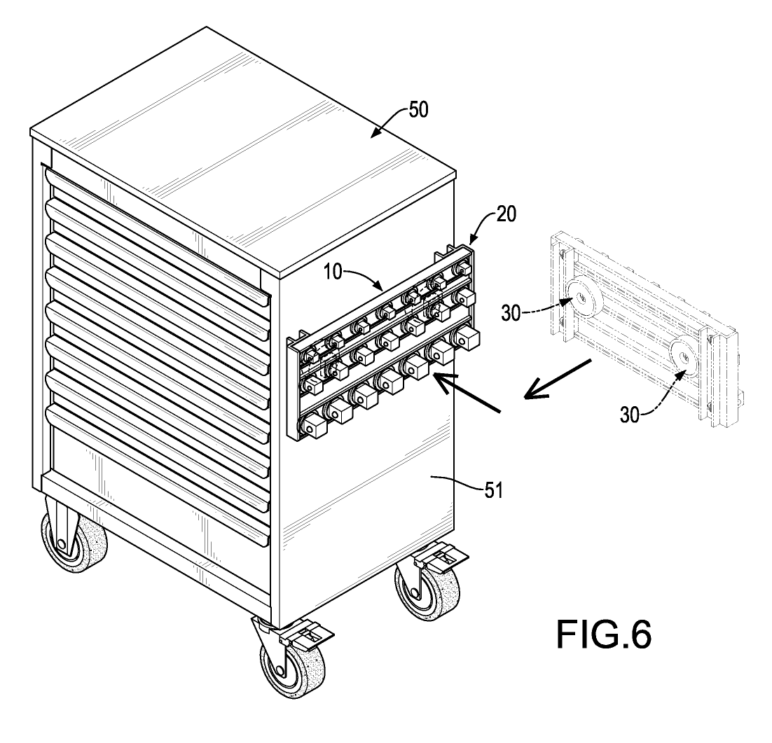

In addition, with further reference to FIGS. 3 and 6, the supporting device 20 and the magnetic device 30 are mounted on the bottom surface of the baseboard 11 and this can prevent the holding racks 15 and the at least one mounting rack 14 from scratching the sidewall 51 of the tool cabinet 50 when the magnetic positioning frame is mounted on the sidewall 51 of the tool cabinet 50. Furthermore, the thicknesses of the magnet blocks 33 are thinner than the depths of the outer casings 32 to enable the top surfaces of the magnet blocks 33 to be mounted in the mounting recesses 322 without extending out of the open tops of the outer casings 32. Then, the top surfaces of the magnet blocks 33 will not scratch the sidewall 51 of the tool cabinet 50 when the magnetic positioning frame is mounted on the sidewall 51 of the tool cabinet 50.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic positioning frame for socket bits comprising:
a track disc having
a baseboard having
a top surface;
a bottom surface; and
two opposite sides including a first side and a second side;
multiple positioning racks formed on and protruding from the top surface of the baseboard at intervals;
multiple positioning blocks mounted slidably in the positioning racks of the track disc;
at least one mounting rack formed on and protruding from the bottom surface of the baseboard; and
multiple holding racks formed on and protruding from the bottom surface of the baseboard and beside the at least one mounting rack;
a supporting device detachably connected to the track disc and having
multiple fixing boards movably mounted in the holding racks adjacent to the opposite sides of the baseboard, and each fixing board having a fixing hole formed through the fixing board;
a first supporting mount connected to the bottom surface and the first side of the baseboard and having
a top;
a bottom;
multiple through holes formed through the bottom and the top of the first supporting mount at intervals and respectively aligning with the fixing holes of the fixing boards that are mounted on the first side of the baseboard; and
multiple screw bolts respectively mounted through the through holes of the first supporting mount and respectively and securely mounted in the fixing holes of the fixing boards via the holding to connect the first supporting mount securely to the fixing boards at the first side of the baseboard and to connect the first supporting mount securely to the bottom surface of the baseboard; and
a second supporting mount connected to the bottom surface and the second side of the baseboard, and having
a top;
a bottom;
multiple through holes formed through the top and the bottom of the second supporting mount at intervals and respectively aligning with the fixing holes of the fixing boards that are mounted on the second side of the baseboard; and
multiple screw bolts respectively mounted through the through holes of the second supporting mount and respectively and securely mounted in the fixing holes of the fixing boards via the holding racks to connect the second supporting mount securely with the fixing boards at the second side of the baseboard and to connect the second supporting mount securely to the bottom surface of the baseboard; and
a magnetic device connected to the track disc and having
at least two attracting modules, and each one of the attracting modules having
a locating board movably mounted in the at least one mounting rack adjacent to one of the supporting mounts and having a connecting hole formed through the locating board;
an outer casing abutting the at least one mounting rack below the baseboard and having
a closed bottom abutting the at least one mounting rack;
an open top;
a through hole formed through the closed bottom of the outer casing and aligning with the connecting hole of the locating board via the at least one mounting rack; and
a mounting recess formed in the outer casing between the closed bottom and the open top of the outer casing and communicating with the through hole and the open top of the outer casing;
a magnet block mounted in the mounting recess of the outer casing and having a holding hole formed through the magnet block and aligning with the through hole of the outer casing and the connecting hole of the locating board; and
a fastener mounted in the holding hole of the magnet block, extending through the through hole of the outer casing and connected to the connecting hole of the locating board via the at least one mounting rack to hold the magnet block and the outer casing securely with the locating board to connect the attracting module securely to the at least one mounting rack below the baseboard.

2. The magnetic positioning frame as claimed in claim 1, wherein
the mounting recess of each one of the at least two attracting modules of the magnetic device has a depth; and
the magnetic block of each one of the at least two attracting modules of the magnetic device has
a top surface; and
a thickness thinner than the depth of the mounting recess to enable the top surface of the magnet block to be mounted in the mounting recess without extending out of the open top of the outer casing.

3. The magnetic positioning frame as claimed in claim 2, wherein
the first supporting mount has
an outer side;
an extending tab formed on and transversally protruding from the outer side of the first supporting mount at the top of the first supporting mount, abutting the bottom surface of the baseboard and having an outer side; and
a side panel formed on and upwardly protruding from the outer side of the extending tab to close the positioning racks and the holding racks at the first side of the baseboard to prevent the positioning blocks from separating from the first side of the baseboard; and
the second supporting mount has
an outer side;
an extending tab formed on and transversally protruding from the outer side of the second supporting mount, formed at the top of the second supporting mount, abutting the bottom surface of the baseboard and having an outer side; and
a side panel formed on and upwardly protruding from the outer side of the extending tab to close the positioning racks and the holding racks at the second side of the baseboard to prevent the positioning blocks from separating from the second side of the baseboard.

4. The magnetic positioning frame as claimed in claim 1, wherein
the first supporting mount has
an outer side;
an extending tab formed on and transversally protruding from the outer side of the first supporting mount at the top of the first supporting mount, abutting the bottom surface of the baseboard and having an outer side; and
a side panel formed on and upwardly protruding from the outer side of the extending tab to close the positioning racks and the holding racks at the first side of the baseboard to prevent the positioning blocks from separating from the first side of the baseboard; and
the second supporting mount has
an outer side;
an extending tab formed on and transversally protruding from the outer side of the first supporting mount at the top of the first supporting mount, abutting the bottom surface of the baseboard and having an outer side; and
a side panel formed on and upwardly protruding from the outer side of the extending tab to close the positioning racks and the holding racks at the second side of the baseboard to prevent the positioning blocks from separating from the second side of the baseboard.
